(19) United States
(12) Patent Application Publication
(10) Pub. No.: US 2006/0201932 A1
(43) Pub. Date: Sep. 14, 2006

(54) Heatable glazing panel

(76) Inventors: Etienne Degand, Jumet (BE); Christophe Meerman, Jumet (BE); Eddy Catot, Jumet (BE)

Correspondence Address: AKERMAN SENTERFITT, P.O. BOX 3188, WEST PALM BEACH, FL, 33402-3188, US

(21) Appl. No.: 10/516,597

(22) PCT Filed: Jun. 4, 2003
(86) PCT No.: PCT/EP03/50213

§ 371 Date: Dec. 3, 2004

(30) Foreign Application Priority Data
Jun. 5, 2002 (EP) 02077253.9

(51) Int. Cl. H05B 3/06

(52) U.S. Cl. 219/543; 219/522

(57) ABSTRACT

The present invention relates to an electrically heatable glazing panel comprising a substantially transparent, electrically conductive coating layer which is adapted to be electrically heatable and is divided into at least two zones, each zone comprising a pair of spaced bus bars and a conductive path located between the pair of spaced bus bars. The glazing panel according to the invention is preferably a side window of a vehicle which may be used for de-misting or de-icing purposes.

The present invention relates to an electrically heatable glazing panel.

In the case of heatable glazing panels comprising an electrically conductive coating layer and being of substantially regular shape, for example rectangular shape, electrical current is brought to a conductive coating layer through, for example, metallic bus bars, which are substantially parallel one to another. In this particular case the distance between the bus bars along their whole length remains substantially the same. The electrical resistance of the current path along the length of the bus bars is therefore substantially the same. When submitting such glazing panels to a given voltage, the amount of heat generated will be substantially uniform throughout the whole surface of the glazing panel covered with the conductive coating layer.

In the case of heatable glazing panels of substantially irregular shape, for example glazing panels with application in the automotive, railway or aeronautical field, spaced bus bars which diverge at at least one portion along their length may be used. The distance between the bus bars therefore varies and consequently the electrical resistance of the current path also varies. Therefore, when submitting such glazing panels to a given voltage, the amount of heat generated will vary along the length of the bus bars, thereby creating the risk of local areas of overheating which may damage or destroy the conductive coating layer. Furthermore, when such heatable glazing panels are used for de-misting or de-icing purposes, certain areas may demist or deice more rapidly than others. This may create problems of visibility for an observer looking through such a glazing panel.

According to one aspect, present invention provides a heatable glazing panel according to Claim 1. Other claims define alternative and/or preferred aspects of the invention.

The heat generated when applying a voltage across the spaced bus bars may be substantially the same over the whole surface of the glazing panel. This may be assessed, for example, by comparing the average temperature at one 5 cm² area of the glazing panel and comparing this with the average temperature at another, spaced 5 cm² area of the glazing panel, particularly when the glazing panel has been heated for a sufficient length of time for it to reach a stable or equilibrium temperature with its surroundings. In one embodiment, the glazing panel may thus be de-iced or de-misted substantially uniformly.

Advantageously, at least one portion of the conductive path extends substantially from a lower edge of the glazing panel to an upper edge of the glazing panel. In this embodiment heat may be generated at substantially the same time at the upper edge and at the lower edge of the glazing panel affording uniform heating at both these edges of the glazing panel.

Preferably, the glazing panel is substantially covered with the electrically conductive coating layer; for example, at least 60%, 70%, 75%, 80% 85%, 90% or 95% of the glazing panel may be covered with the coating layer. This may provide a glazing panel with optical properties (for example reflection, colour in reflection, total visible light transmission, total energy transmission) which are substantially the same in each zone and preferably substantially the same over the entire visible surface of the glazing.

Preferably, the glazing panel comprises more than two electrically heatable zones, for example, 3, 4, 5, 6, 7, 8, 9, 10, 12, 15, 20, 30 or more zones.

Arranging for the conductive path of an electrically heatable zone to change direction at least once along its length within the electrically conductive coating layer so as to double back upon itself may enable the length of the conductive path to be designed independently of the size, shape or configuration of the glazing panel. This may allow the electrical resistance of the conductive path to be selected at different portions of the glazing panel without direct limitation to the height, shape or configuration of the glazing panel at the portion in question. In some embodiments, this may be used to achieve substantially even heating over the entire surface of the glazing panel, particularly where substantially the same voltage is applied across each electrically conductive heatable zone. The conductive path of an electrically heatable zone which changes direction at least once along its length within the electrically conductive coating layer so as to double back upon itself may be configured in the form of a loop, a u-shaped loop, an s-shaped loop or a snake-like loop.

Preferably, the glazing panel comprises at least two electrically heatable zones in which the conductive path changes direction at least once along its length within the electrically conductive coating layer so as to double back upon itself. In some embodiments, the length of the conductive path at these two electrically heatable zones, and preferably at all electrically heatable zones, is substantially the same.

Advantageously, the glazing panel comprises at least 3, 4, 5, 6, 7, 8, 9, 10, 11, 12, 13, 14, 15 or 20 electrically heatable zones in which the conductive path changes direction at least once along its length within the electrically conductive coating layer so as to double back upon itself.

The variation of temperature across at least two adjacent electrically heatable zones, more preferably across all electrically heatable zones of the glazing panel, may be less than 15° C. and preferably less than 12° C., 10° C., 8° C., 5° C. or 2° C. particularly when a voltage is applied across the coating layer of the glazing panel via first and second bus bars and after the glazing panel has reached stable or equilibrium conditions with its surroundings, the surroundings being at room temperature. In a particular embodiment of the glazing panel, the average temperature across all electrically heatable zones once equilibrium conditions have been reached is of about 40° C.

Alternatively, the glazing panel may be defined with preferential electrically heatable zones. The length of the conductive path of a preferential electrically heatable zone may be different from the length of the conductive path of another electrically heatable zone of the glazing panel so that, if required, this preferential zone may be heated more rapidly than the other heatable zone.

One or more electrically heatable zone may comprise a distinct pair of bus bars. The expression “distinct pair of bus bars” as used herein means that the bus bars serve only a single electrically heatable zone. Alternatively, one or more bus bars may be adapted so as to serve more than one electrically heatable zone.

The polarity of each of the bus bars may remain the same when a voltage is applied between the bus bars in use. Thus, in use, the direction of current flow in each conductive path may be constant. Preferably, the conductive paths have a fixed configuration, that is to say, the configuration of the conductive paths is not changed or varied during a heating cycle of the glazing. Preferably, the voltage is applied to all of the bus bars at the same time in order to favour a rapid and uniform heating of the glazing panel.

Advantageously, the bus bars are located along the length of a same edge of the glazing panel, for example, along a lower edge of the glazing panel; this may facilitate masking of the bus bars from view, for example, by covering the bus bars with an enamel or other masking agent or by arranging for the bus bars to be hidden in use, for example by part of the bodywork of a vehicle.

The electrically heatable zones may be delimited by one or more zone boundaries which are substantially insulating. The expression “substantially insulating” as used herein refers to a zone boundary which is less electrically conductive than the coating layer or which is substantially non conductive of electrical current.

A zone boundary may be provided by applying pattern wise over the conductive coating layer a material which is less conductive than the coating layer. Preferably, zone boundaries are provided by one or more non-coated portion of the glazing panel. The one or more non-coated portion may have an electrical resistance such that substantially no electrical current flows through it when a voltage is applied between the bus bars and thus may be substantially not conductive. The one or more non-coated portion may be provided by applying pattern wise to the substrate a masking agent before depositing the electrically conductive layer and removing subsequently the masking agent covered with the coating layer. Alternatively, the one or more non-coated portion may be provided by removal of the conductive coating layer after deposition. Advantageously, the coating layer may be removed with a laser, for example a laser DIODE. The zone boundaries may be substantially invisible to the naked eye, particularly if formed by laser removal of part of the coating layer. Advantageously, the width of the zone boundary is less than 150 μm, preferably less than 100 μm, more preferably less than 50 μm, most preferably less than 10 μm. A zone boundary may delimit or substantially delimit one electrically heatable zone from another electrically heatable zone.

The bus bars may be formed by deposition of a noble metal paste, for example a silver paste, or by deposition of a metallic ribbon.

Arranging the electrically conductive coating layer to be a solar control coating layer may enable the functions of preventing excessive passage of solar energy through the glazing to be combined with the heatability of the glazing panel. The term “solar control” refers herein to a coating layer which increases the selectivity of a substrate, that is, increases the ratio of incident visible light transmitted through a substrate to the incident solar energy transmitted through the substrate. Alternatively, the conductive coating layer may be a low emissivity coating.

The conductive coating layer may be deposited by a vacuum deposition technique, for example by magnetron sputtering, or be pyrolytically formed, for example by chemical vapour deposition. The coating layer is preferably applied over the entire surface or over the majority of the surface of the substrate.

In a preferred embodiment of the present invention, the coating film comprises at least one metallic infra-red reflective layer. The coating film may comprise a sequence of layers as follows: dielectric layer/silver/dielectric layer or dielectric layer/silver/dielectric layer/silver/dielectric layer. The dielectric layers may comprise, for example, tin oxide, zinc oxide, silicon nitride, titanium oxide, aluminium oxide or mixtures of one or more thereof.

The electrically conductive coating layer preferably has a resistance comprised between 2 and 100 ohms per square, preferably between 2 and 25 ohms per square, for example, 2.2, 3.0, 15 or 20 ohms per square.

In the glazing panel according to the present invention, the substrate may be glass, for example a sheet of flat glass, soda lime glass or float glass, particularly a sheet of glass intended for subsequent use as or incorporated in an architectural or vehicle glazing panel. It may undergo a thermal toughening treatment or a bending treatment before or after the coating layer has been deposited onto at least part of its surface. Alternatively, the substrate may be a rigid or flexible plastics sheet material which may equally be intended for subsequent use as or incorporated in an architectural or vehicle glazing panel.

The electrically conductive coating layer may be provided directly at a surface of the substrate, alternatively, it may be carried by a film, for example, a PET or other plastics sheet material incorporated in a glazing panel.

The present invention is particularly applicable to a glazing panel of substantially irregular shape, that is, a glazing panel which has an acute angle α formed by the lower edge of the glazing panel and by the tangent to a side edge, particularly where α is less than or equal to 60°, 55°, 45°, 40°, 35°, 30°, 25°, 20° or 15° and even more particularly where the first and second bus bars are positioned along or adjacent to those edges. In one embodiment of the invention, at least one edge of the glazing panel may be substantially curved.

The glazing panel may be a side window of a vehicle or a train, a windshield of an aircraft or a glazing panel with applications in the nautical field.

The glazing panel may be adapted to have a voltage of between 10 and 100 volts applied across the bus bars, preferably between 30 and 50 volts. For automobile applications, a voltage of 32 volts, more preferably 36 volts, most preferably 42 volts, is applied. Alternatively, the glazing panel may be adapted to have a voltage of between 10 and 14 volts applied across the bus bars, for example about 12 volts. The heat generated by the zone heatable electrically is preferably comprised between 250 and 750 watts per square meter.

In embodiments in which more than one pair of spaced bus bars are provided, the glazing panel may be adapted to have the same or substantially the same voltage applied across each pair of bus bars.

Particularly where the glazing panel is provided in monolithic form, the electrically conductive coating layer may be partially or entirely covered with an additional external coating (which is preferably substantially non electrically conductive), for example a lacquer. This may prevent the electrically conductive coating from being an exposed coating layer and may serve:
to provide electrical insulation between the electrically conductive coating and its surroundings; and/or
to protect the electrically conductive coating from abrasion; and/or
to reduce tendencies for the electrically conductive coating and/or the zone boundaries to accumulate dirt and/or to become difficult to clean.

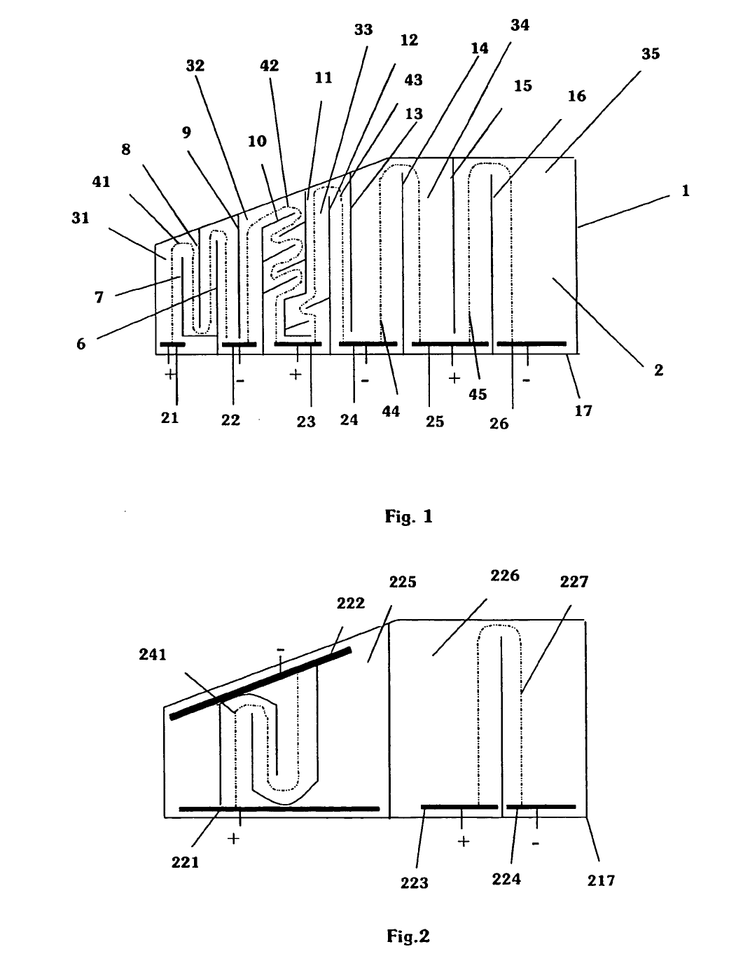

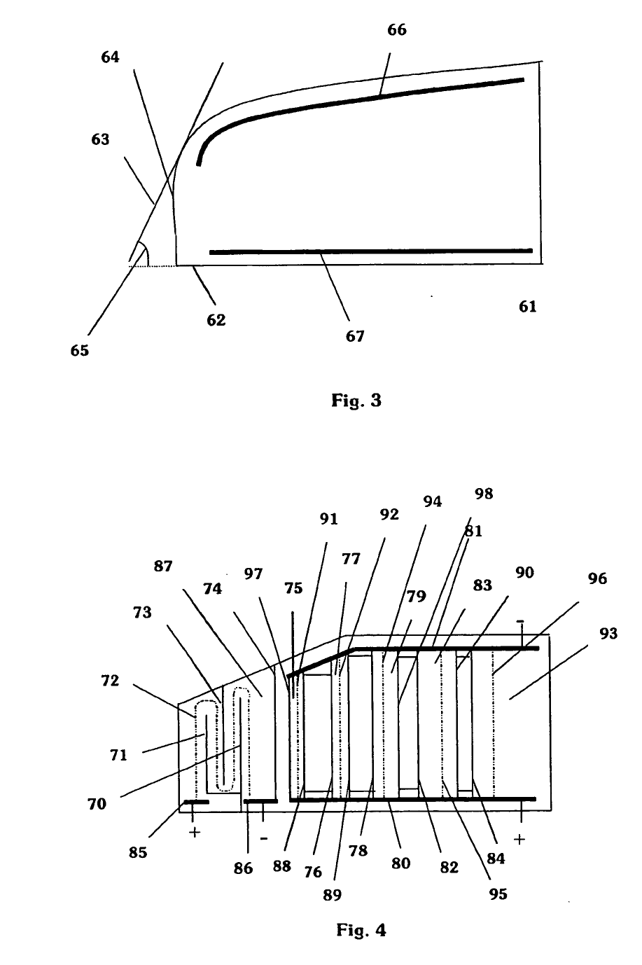

The invention will now be described, by way of example only, with reference to FIG. 1, FIG. 2, FIG. 3 and FIG. 4 which are schematic representations of a glazing panel.

FIG. 1 shows a glazing panel (17) in the form of a moveable, automotive side window comprising a glass sheet (1), a substantially transparent, electrically conductive coating layer (2) over substantially the entire surface of the glazing, bus bars (21, 22, 23, 24, 25, 26), and insulating zone boundaries (6), (7), (8) (9), (10), (11), (12), (13) (14), (15) and (16) which delimit five electrically heatable zones (31, 32, 33, 34, 35). Each bus bar is formed by screen-printing a layer of silver paste of 10 μm thickness and 5 mm width. The coating layer has a resistance of about 15 ohms per square and is formed by deposition over the surface of the glazing panel.

A conductive path (41) of the first electrically heatable zone (31) is defined between the bus bars (21, 22) which are adapted to apply an electrical voltage across this electrically heatable zone. Similarly, conductive paths (42, 43, 44, 45) are defined between the bus bars serving the second (32), third (33), forth (34) and fifth (35) electrically heatable zones. In this embodiment, the conductive path (41) at the first electrically heatable zone doubles back on itself three times within the electrically conductive coating whilst those of the other zones each double back upon themselves once within the electrically conductive coating.

Bus bars are shared between different zones, for example bus bar (22) serving to apply a voltage across both the first (31) and second (32) electrically heatable zones.

The lengths and the electrical resistance of each conductive path are substantially equal despite the fact that they are arranged at portions of the glazing panel of unequal height.

The bus bars may be hidden in use by concealment of the lower edge of the glazing panel in a vehicle door in which the glazing panel is adapted to be mounted.

In the arrangement of FIG. 2, the conductive path (241) changes direction within the electrically conductive coating so as to double back upon itself twice at a first heatable zone (225) between a bus bar (221) positioned at a lower edge of the glazing panel (217) and a bus bar (222) positioned at an upper edge of the glazing panel. The conductive path (227) doubles back upon itself once at a second heatable zone (226) between bus bars (223, 224) located at a lower edge of the glazing panel.

FIG. 3 shows a glazing panel of substantially irregular shape (61) comprising spaced bus bars (66, 67), which glazing panel has an acute angle α (65) formed by the lower edge (62) of the glazing panel and by the tangent (63) to a side edge (64) of the glazing panel.

FIG. 4 shows a glazing panel of substantially irregular shape comprising spaced bus bars (80, 81, 85, 86), electrically heatable zones (87, 75, 77, 79, 83, 93) delimited by zone boundaries (70, 71, 73, 74, 97, 88, 76, 89, 78, 98, 82, 90, 84). A conductive path (72) is defined between bus bars (85) and (86) and conductive paths (91, 92, 94, 95, 96) are defined between bus bars (80) and (81). The conductive path (72) at a first electrically heatable zone (87) changes direction and doubles back upon itself three times whereas conductive paths (91, 92, 94, 95, 96) in the other electrically heatable zones (75, 77, 79, 83, 93) have a single direction. The length of at least two conductive paths located in at least two electrically heatable zones varies.

FIG. 1 also shows a bus bar arrangement in which first, second, third fourth, fifth and sixth bus bars (21, 22, 23, 24, 25, 26) are arranged co-axially or co-linearly in order and along the lower edge of the glazing panel. A first electrically heatable pathway (41) is defined between the first and second bus bars (21, 22), a second electrically heatable pathway (42) is defined between the second and third bus bars (22,23), a third electrical pathway (43) is defined between the third and fourth bus bars (23, 24), and so on. In this embodiment, the electrically heatable pathways are provided by delimited portions of the electrically conductive coating layer (2). Alternatively, electrically heatable pathways may be provided by electrically heatable wires.

In use, the second, fourth and sixth bus bars (22, 24, 26) are maintained at the same negative electrical potential whilst the first, third and fifth bus bars (21, 23, 25) are maintained at the same positive potential (it would, of course be possible to inverse these electrical potentials). In this way, the second bus bar (22) serves to apply a voltage across both the first (41) and second (42) electrically heatable pathways, the third bus bar (23) serves to apply a voltage across both the second (42) and third (43) electrically heatable pathways, and so on.

1. An electrically heatable glazing panel comprising a substrate and at least two electrically heatable zones, each electrically heatable zone comprising:
i) a substantially transparent, electrically conductive coating layer,
ii) spaced bus bars adapted to supply electrical voltage across the substantially transparent, electrically conductive coating layer, and
iii) a conductive path defined between the bus bars,
in which, at at least one of the electrically heatable zones the conductive path changes direction at least once along its length within the electrically conductive coating layer so as to double back upon itself.

2. An electrically heatable glazing panel according to claim 1 in which at least one portion of the conductive path extends substantially from a lower edge of the glazing panel to an upper edge of the glazing panel.

3. An electrically heatable glazing panel according to claim 1 in which at at least two electrically heatable zones, the conductive path changes direction at least once along its length within the electrically conductive coating layer so as to double back upon itself.

4. An electrically heatable glazing panel according to claim 3 in which the length of the conductive path is substantially the same in each zone.

5. An electrically heatable glazing panel according to claim 1 in which all of the bus bars are located along the length of a same edge of the glazing panel.

6. An electrically heatable glazing panel according to claim 5 in which the bus bars are provided along the length of the lower edge of the glazing panel.

7. An electrically heatable glazing panel according to claim 1 in which the electrically heatable zones are delimited by at least one zone boundary which is substantially insulating.

8. An electrically heatable glazing panel according to claim 7 in which the one or more zone boundaries are provided by non-coated portions of the glazing panel.

9. An electrically heatable glazing panel according to claim 9 in which the one or more zone boundaries have a width of less than 150 μm.

10. An electrically heatable glazing panel according to claim 1 in which the coating layer is a solar control coating layer.

11. An electrically heatable glazing panel according to claim 1 in which the coating layer has a resistance comprised between 2 and 25 to ohms/square.

12. An electrically heatable glazing panel according to claim 1 in which the substrate is a glass sheet.

13. An electrically heatable glazing panel according to claim 1 in which the glazing panel is thermally toughened.

14. An electrically heatable glazing panel according to claim 1 in which the glazing panel is laminated.

15. An electrically heatable glazing panel according to claim 1 in which the glazing panel is an automotive side window.

16. An electrically heatable glazing panel according to claim 1 in which the glazing panel has at least one acute angle.

17. An electrically heatable glazing panel according to claim 16 in which the glazing panel is of substantially triangular shape.

18. An electrically heatable glazing panel according to claim 1 in which the electrically conductive coated layer is deposited directly on a surface of the substrate.

19. An electrically heatable glazing panel according to claim 1 in which the electrically conductive coated layer is carried by a thin plastic film assembled as part of the glazing panel.

20. An electrically heatable glazing panel according to claim 1 in which the variation in temperature across all electrically heatable zones is less than 15° C. when a voltage is applied across the coating layer of the glazing panel via the spaced bus bars and after the glazing panel has reached equilibrium conditions with its surroundings, the surroundings being at room temperature.

21. An electrically heatable glazing panel comprising
spaced first, second and third electrical bus bars arranged in order at and along an edge of the glazing panel
a first electrically heatable pathway defined between the first and the second bus bars
a second electrically heatable pathway defined between the second and the third bus bars.

22. An electrically heatable glazing panel in accordance with claim 21, which is adapted to provide for electrical heating of the first electrically heatable pathway by means of a difference in electrical potential applied between the second and first bus bars and which is adapted to provide for electrical heating of the second electrically heatable pathway by means of a difference in electrical potential applied between the second and third bus bars.

23. An electrically heatable glazing panel in accordance with claim 21, in which the first and third bus bars are adapted to be maintained at substantially the same electrical potential for heating of the first and second electrically heatable pathways.

24. An electrically heatable glazing panel in accordance with claim 21, in which, for heating of the first and second electrically heatable pathways, the second bus bar is adapted to be maintained at a negative electrical potential and the first and the third bus bars are adapted to be maintained at a positive electrical potential.

25. An electrically heatable glazing panel in accordance with claim 21, in which the glazing panel further comprises
a fourth electrical bus bar spaced from and arranged in order with the first, second and third electrical bus bars at and along an edge of the glazing panel
a third electrically heatable pathway defined between the third and the fourth bus bars.

26. An electrically heatable glazing panel in accordance with claim 25, further comprising
a fifth electrical bus bar spaced from and arranged in order with the first, second, third and fourth electrical bus bars at and along an edge of the glazing panel a fourth electrically heatable pathway defined between the fourth and the fifth bus bars.

27. An electrically heatable glazing panel in accordance with claim 21, in which the electrically heatable pathways are provided by portions of an electrically heatable coating layer provided as part of the glazing panel.

28. An electrically heatable glazing panel in accordance with claim 21, in which the electrically heatable pathways are provided by electrically heatable wires.

29. An electrically heatable glazing panel in accordance with claim 21, in which the bus bars are substantially parallel and/or substantially co-linear and/or substantially co-axial.
